(19) United States
(12) Patent Application Publication
(10) Pub. No.: US 2009/0016501 A1
(43) Pub. Date: Jan. 15, 2009

(54) OFF-HOOK DETECTION SYSTEM, METHOD, AND COMPUTER PROGRAM PRODUCT

(75) Inventors: John May, Roswell, GA (US); Ian Linsdell, Roswell, GA (US); Brian Boyer, Alpharetta, GA (US)

Correspondence Address: DLA PIPER LLP US, P. O. BOX 2758, RESTON, VA, 20195, US

(73) Assignee: Recordant, Inc., Alpharetta, GA (US)

(21) Appl. No.: 11/777,524

(22) Filed: Jul. 13, 2007

(51) Int. Cl. H04M 11/00

(52) U.S. Cl. 379/93.09

(57) ABSTRACT

An exemplary embodiment of the invention may include a system, a method and/or a computer program product for enabling detecting the off-hook status of a telephony device, including, e.g., but not limited to, monitoring an earpiece channel of the telephony device to detect an earpiece audio signal associated with a telephone call; initiating a recording of the telephone call upon detecting said earpiece audio signal on the earpiece channel; injecting a signal having a predetermined frequency into a microphone channel of the telephony device; and terminating said recording if the injected signal is not detected in a sidetone on the earpiece channel.

### BACKGROUND OF THE INVENTION

1. Field of the Invention

The invention relates generally to telephony devices, and more particularly to detecting a beginning and an end of a conversation on a telephony device.

2. Background of the Invention

Today, a variety of quality monitoring and assurance solutions are marketed to call center channels to improve customer experience and increase sales and service satisfaction. Such quality monitoring and assurance solutions typically involve recording a phone conversation between a customer and a sales/service representative and storing the recording for future processing. For example, these recordings can be saved for future reference, such as for quality assurance or in a case of a customer complaint. The recordings may also be used in reviewing a representative's performance or training new representatives. Also, statistical analysis may be performed on the recordings cumulatively in order to evaluate, for example, a company's sales performance as a whole. Various speech recognition techniques may be used in conjunction with the recordings to assist in performing such statistical analysis on the recordings automatically.

In order to efficiently record and store the phone conversations, it is critical to identify the beginning and end of every call so that multiple phone conversations do not get recorded into a single recording. Conventionally, it is possible to allow sales/service representative to start and stop the recording manually, e.g., via a start/stop button. However, in some instances, the sales/service representative may neglect or even avoid recording a phone conversation, which could lead to an inefficient monitoring and quality assurance system altogether. Also, in some instances, the sales/service representative may forget to stop a recording in a timely fashion such that large amounts of unwanted audio are recorded along with the phone conversation. Thus, such manual control is often undesirable for detecting the beginning and end of a phone conversation. For this reason, it is advantageous to implement a system capable of automatic off-hook detection, i.e., when the telephone is in use.

A conventional method of off-hook detection is by using or retrieving the phone's off-hook status from signaling information. However, access to signaling information differs by the phone type. Some signaling is in-band and others may be out-of-band. Also, for a Voice over Internet Protocol (VoIP) phone, signaling information may reside in packets. As a result, the off-hook detection device would have to be compatible with the phone's processor. For example, an off-hook detection device designed for Plain Old Telephone Service (POTS) analog phones may not work with VoIP digital phones. Also, different phone manufacturers may utilize different methods of signaling and switching, so an off-hook detection device compatible with one VoIP phone may not be compatible with another VoIP phone. Thus, what is needed is an off-hook detection device that is compatible with a vast majority of telephony devices, including POTS, digital Private Branch eXchange (PBX), and VoIP phones, without requiring tailing the device to the specific design of the phone. Further, what is needed is an off-hook detection device capable of accurately detecting the beginning and the end of phone conversations in the various telephony devices.

### SUMMARY OF THE INVENTION

According to an embodiments of the present invention, there are provided a system, a method, and a computer program product for off-hook detection of a telephony device.

According to an aspect of the present invention, a system is provided for off-hook detection of a telephony device, which may include, in an exemplary embodiment, an earpiece audio sensor operative to detect an earpiece audio signal associated with a telephone call on an earpiece channel of a handset of the telephony device; a signal generator arranged to inject a signal having a predetermined frequency into a microphone channel of the handset the telephony device; and an audio processor configured to initiate a recording of the telephone call upon the earpiece audio sensor detecting the earpiece audio signal and to terminate the recording if the injected signal is not detected in a sidetone on the earpiece channel.

According to a an exemplary embodiment, the audio processor may be configured to initiate the recording if the earpiece audio signal has an energy level greater than a trigger energy threshold. In a further exemplary embodiment, the audio processor may be configured to initiate the recording if, for a predetermined number of fragments of the earpiece audio, an energy level of each fragment exceeds a trigger energy threshold.

In an exemplary embodiment, the audio processor may be operative to play an audio announcement at a beginning of the telephone call alerting a user that the telephone call is being recorded for quality assurance purposes. Also, in an exemplary embodiment, the audio processor may be operative to play a beep tone to a user at predetermined time intervals indicating that the telephone call is being recorded.

In an exemplary embodiment, the exemplary system of the present invention may further include a microphone audio sensor arranged to detect a microphone audio signal of the handset associated with the telephone call on the microphone channel of the handset of the telephony device. In an exemplary embodiment, the microphone audio sensor and the earpiece audio sensor may detect an audio signal associated with the telephone call prior to the signal generator injecting the injected signal into the microphone channel, wherein the signal generator may be configured to inject the injected signal into the earpiece channel if an end of the telephone call is presumed, where the end of the telephone call may be presumed if a minimal amount of audio energy is detected on the earpiece audio channel and/or the microphone audio channel.

In a further exemplary embodiment, the end of the telephone call may be presumed if a combined audio energy level on the earpiece audio channel and the microphone audio channel is below a wrap-up energy threshold. In a yet further exemplary embodiment, a VOX switch may be provided to determine whether the combined audio energy level is below the wrap-up energy threshold. In a further exemplary embodiment, the end of the telephone call may be presumed if a combined audio energy level on the earpiece audio channel and the microphone audio channel is below a wrap-up energy threshold for a minimum of a wrap-up duration period.

In an exemplary embodiment, the audio processor may be further operative to terminate the recording if a combined audio energy level on the earpiece audio channel and the microphone audio channel is above a wrap-up energy threshold for a maximum record duration period.

In an exemplary embodiment, the injected signal may include a non-intrusive sub-band signal. In an exemplary embodiment, the injected signal may have an audio frequency of approximately 100 Hz.

In an exemplary embodiment, the earpiece audio sensor may be operative to monitor the earpiece channel to detect the injected signal in the sidetone. In an exemplary embodiment, the audio processor may be further operative to measure zero-crossings on the earpiece channel to detect a candidate sidetone signal likely to correspond to the injected signal. In a yet further exemplary embodiment, the audio processor may be further operative to detect the injected signal in the sidetone using a Goertzel algorithm.

In an exemplary embodiment, the signal generator may be arranged to inject a plurality of signals into the microphone channel and the audio processor may be operative to terminate the recording if the plurality of injected signals are not detected on the earpiece channel for a sidetone wrap-up duration period. In a further exemplary embodiment, the signal generator may be arranged to inject a plurality of signals into the microphone channel and the audio processor may be operative to terminate the recording if, for each of the plurality of injected signals, the injected signal is detected on the earpiece channel for a maximum sidetone fallback duration period.

According to another aspect of the present invention, a method is provided for off-hook detection of a telephony device, which may include, in an exemplary embodiment, monitoring an earpiece channel of a handset of the telephony device to detect an earpiece audio signal associated with a telephone call; initiating a recording of the telephone call upon detecting the earpiece audio signal on the earpiece channel; injecting a signal having a predetermined frequency into a microphone channel of the handset of the telephony device; and terminating the recording if the injected signal is not detected in a sidetone on the earpiece channel.

In an exemplary embodiment, the recording may be initiated if the earpiece audio signal has an energy level greater than a trigger energy threshold. In another exemplary embodiment, the recording may be initiated if, for a predetermined number of fragments of the earpiece audio, an energy level of each fragment exceeds a trigger energy threshold.

In an exemplary embodiment, the method may further include playing an audio announcement at a beginning of the telephone call alerting a party to the telephone call that the telephone call is being recorded for quality assurance purposes. In an exemplary embodiment, the method may playing a beep tone to a party to the telephone call at predetermined time intervals, indicating that the telephone call is being recorded.

In an exemplary embodiment, the method may further include monitoring the earpiece and the microphone channels of the handset to detect audio associated with the telephone call prior to injecting the injected signal into the microphone channel, wherein an end of the telephone call may be presumed if minimal audio is detected on either the earpiece audio channel or the microphone audio channel, where the injected signal may be injected into the earpiece channel if the end of the telephone call is presumed.

In an exemplary embodiment, the end of the telephone call may be presumed if a combined audio energy level on the earpiece audio channel and the microphone audio channel is below a wrap-up energy threshold. In an exemplary embodiment, a VOX switch may be used to determine whether the combined audio energy level on the earpiece audio channel and the microphone audio channel is below the wrap-up energy threshold.

In an exemplary embodiment, the end of the telephone call may be presumed if a combined audio energy level on the earpiece audio channel and the microphone audio channel is below a wrap-up energy threshold for a minimum of a wrap-up duration period.

In an exemplary embodiment, the method may further include terminating the recording if a combined audio energy level on the earpiece audio channel and the microphone audio channel is above a wrap-up energy threshold for a maximum record duration period.

In an exemplary embodiment, the injected signal may include a non-intrusive sub-band signal. In a further exemplary embodiment, the injected signal may have an audio frequency of approximately 100 Hz.

In an exemplary embodiment, the terminating step may include monitoring the earpiece channel of the handset to detect the injected signal in the sidetone. In an exemplary embodiment, the terminating may further include measuring zero-crossings on the earpiece channel to detect a candidate sidetone likely to correspond to the injected signal.

In an exemplary embodiment, the terminating step may include detecting the injected signal in the sidetone using a Goertzel algorithm. In a further exemplary embodiment, the terminating step may further include detecting the injected signal in the sidetone using at least one of a FFT algorithm and/or a DFT algorithm.

In an exemplary embodiment, the method may further include injecting a plurality of signals into the microphone channel for a sidetone wrap-up duration period; monitoring the earpiece channel for at least one sidetone corresponding to at least one of the plurality of injected signals; and terminated the recording if none of the plurality of injected signals is detected on the earpiece channel.

According to another aspect of the present invention, there is provide a computer readable medium embodying program logic, which, when executed, performs a method which may include, in an exemplary embodiment, monitoring an earpiece channel of a handset of the telephony device to detect an earpiece audio signal associated with a telephone call; initiating a recording of the telephone call upon detecting the earpiece audio signal on the earpiece channel; injecting a signal having a predetermined frequency into a microphone channel of the handset of the telephony device; and terminating the recording if the injected signal is not detected in a sidetone on the earpiece channel. In an exemplary embodiment, the recording is initiated if the earpiece audio signal has an energy level greater than a trigger energy threshold.

In an exemplary embodiment, the method executed by the program logic may further include monitoring the earpiece and the microphone channels of the handset to detect audio associated with the telephone call prior to injecting the injected signal into the microphone channel, wherein an end of the telephone call may be presumed if minimal audio is detected on either the earpiece audio channel or the microphone audio channel, wherein the injected signal may be injected into the earpiece channel if the end of the telephone call is presumed.

In an exemplary embodiment, the telephone call may be presumed if a combined audio energy level on the earpiece audio channel and the microphone audio channel is below a wrap-up energy threshold for a minimum of a wrap-up duration period.

In an exemplary embodiment, the injected signal comprises a non-intrusive sub-band signal.

In an exemplary embodiment, the terminating step of the method executed by the program logic may include monitoring the earpiece channel of the handset to detect the injected signal in the sidetone. In an exemplary embodiment, the terminating step may further include measuring zero-crossings on the earpiece channel to detect a candidate sidetone likely to correspond to the injected signal. In an exemplary embodiment, the terminating may further include detecting the injected signal in the sidetone using at least one of a Goertzel algorithm, a DFT algorithm, and/or a FFT algorithm.

### BRIEF DESCRIPTION OF THE DRAWINGS

Various exemplary features and advantages of the invention may be apparent from the following, more particular description of exemplary embodiments of the present invention, as illustrated in the accompanying drawings wherein like reference numbers generally indicate identical, functionally similar, and/or structurally similar elements. The left most digits in the corresponding reference number indicate the drawing in which an element first appears:

FIG. 1 depicts a block diagram of an exemplary telephone according to an exemplary embodiment of the present invention;

FIG. 2 depicts an exemplary block diagram of an off-hook detection device connected to the handset of a telephone according to an exemplary embodiment of the present invention;

FIG. 3A-B illustrate exemplary DTMF keypad frequencies and DTMF event frequencies, respectively;

FIG. 4A depicts an exemplary off-hook detection device coupled to a telephone handset according to an exemplary embodiment of the present invention;

FIG. 4B depicts an exemplary side-view of an off-hook detection device interface according to an exemplary embodiment of the present invention;

FIG. 5A-C depict an exemplary flow diagram of an exemplary off-hook detection process according to an exemplary embodiment of the present invention; and

FIG. 6 depicts an exemplary embodiment of a computer system as may be used in an exemplary embodiment of the present invention.

### DETAILED DESCRIPTION

### Glossary of Terms with Exemplary but Non-Limiting Definitions

Sidetone—In telephony, sidetone is the effect of sound that is picked up by the telephone's mouthpiece and reproduced by the earpiece of the same handset, acting as feedback that the phone is really working. The sidetone helps people control the level of their voice and makes them aware that the phone is connected. Typically the speaker does not consciously notice the sidetone during a phone call. However, if there is no sidetone, the user cannot hear their own voice in the earpiece and the telephone user may think the phone is not working or has been disconnected. Too much sidetone may cause the phone user to hear their own voice loudly, which may cause them to feel uncomfortable and lower the level of their voice. In analog phones, the presence and/or level of sidetone typically depends on the electrical characteristics of the connection between the phone and the user's local central office. Digital telephones and cell phones usually lack the mechanical acoustics and circuitry which created sidetone in analog phones, so digital phones may include electronic circuitry to reproduce the sidetone.

Off-Hook—The status of a telephony device when that device is in use in a communication, i.e., a connection exists between the telephony device and another telephony device allowing a communication.

DTMF—In telephony, dual-tone multi-frequency (DTMF) signaling is used for telephone signaling over the line in the voice-frequency band to the call switching center. The version of DTMF used for telephone tone dialing is known by the trademarked term Touch-Tone. With DTMF, each key on the telephone keypad is assigned two tones of specific frequency, one from a high-frequency group of tones and the other from a low-frequency group of tones. When a telephone key is pressed by a user, the phone generates the two tones simultaneously. Since a human can only make one sound at a time, human voice cannot imitate the DTMF tones. There are also DTMF tones for, e.g., but not limited to, a busy signal, a dial tone, and a ringback tone.

Goertzel Algorithm—The Goertzel algorithm is a digital signal processing (DSP) technique for identifying frequency components of a signal. While the general Fast Fourier transform (FFT) algorithm computes evenly across the bandwidth of the incoming signal, the Goertzel algorithm looks at specific, predetermined points. The Goertzel algorithm is often used for detection of DTMF tones.

Zero-Crossing—In a signal, the zero crossing is the instantaneous point at which there is no voltage present. In a sine wave or other simple waveform, this normally occurs twice during each cycle. Zero crossings may be used to estimate the frequencies and formants speech.

### Exemplary Embodiments of an Off-Hook Detection Device

Various exemplary embodiments including a preferred embodiment of the present invention are discussed in detail below. While specific exemplary embodiments are discussed, it should be understood that this is done for illustration purposes only. A person skilled in the relevant art will recognize that other components and configurations may be used without parting from the spirit and scope of the invention.

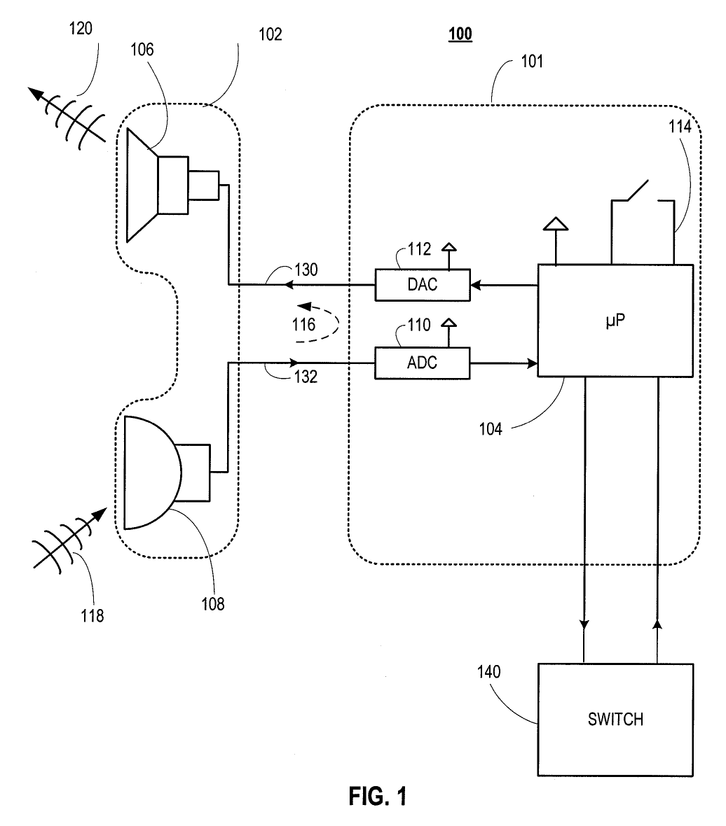

FIG. 1 depicts a block diagram of an exemplary telephone 100 having a handset 102 coupled to a base 101. The depicted exemplary telephone 100 may be a digital phone which may include a microprocessor 104. The handset 102 may include an earpiece 106 and a microphone 108. The microphone 108 may be coupled to the microprocessor 104 of the base 101 through an Analog-to-Digital Converter (ADC) 110, which may transform the audio 118 received by the microphone 108 into digital data to be processed by the microprocessor 104. Similarly, the earpiece 106 may be coupled to the microprocessor 104 through a Digital-to-Analog Converter (DAC) 112, which may transform the digital data from the microprocessor 104 into analog data which, in turn, is transformed to audio 120 by the earpiece 106. In an exemplary embodiment, the ADC 110 and the DAC 112 may be included inside the base 101. Therefore, the microphone channel 132 and the earpiece channel 130, which connect the microphone 108 and the earpiece 106 to the ADC 110 and the DAC 112, respectively, both carry analog data therein.

In an exemplary embodiment, when the phone is off-hook, i.e., there is connectivity between the phone and another telephony device, the user's voice may come back through the earpiece 106 as a sidetone 116. The sidetone 116 may be the feedback of audio picked up by the microphone 108, which is usually slightly audible but not consciously noticeable by the phone user. In analog phones as well as many modern digital phones, the sidetone is created by the switch 140, through which the phone base 101 may communicate with other telephony devices. In many VoIP phones as well as mobile phones, where the phone may not be directly connected to a switch 140, the sidetone 116 may be created artificially, such as, e.g., inside the phone base 101.

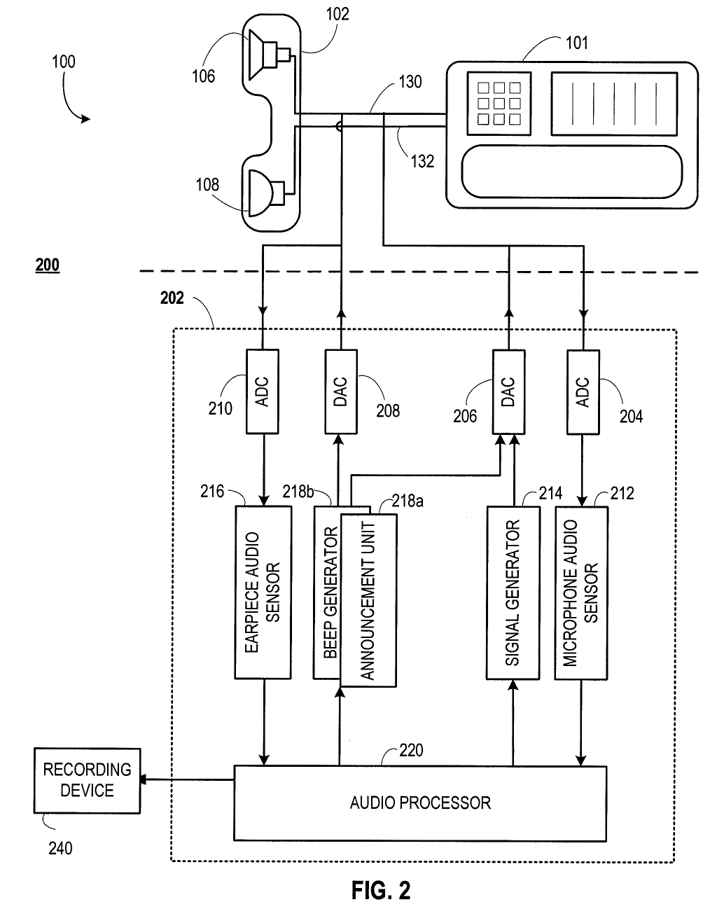

Referring now to FIG. 2, there is depicted an exemplary block diagram 200 of an off-hook detection device 202 coupled to the telephone 100 at the interface between the handset 102 and the base 101 of FIG. 1, according to an embodiment of the present invention. In an exemplary embodiment, the off-hook detection device 202 may include an ADC 204 and/or a DAC 206, through which the device 202 may connect to the microphone channel 132 of the telephone 100. The off-hook detection device 202 may similarly include a DAC 208 and/or an ADC 210 through which the device 202 may connect to the earpiece channel 130 of the telephone 100.

According to an exemplary embodiment of the invention, the off-hook detection device 202 may include a microphone audio sensor 212 which may be coupled to the ADC 204 and may monitor the signal activity on the telephone's microphone channel 132. In an exemplary embodiment, the off-hook detection device 202 may also include an earpiece audio sensor 216 which may be coupled to the ADC 210 and may monitor the signal activity on the telephone's earpiece channel 130. Together, the microphone audio sensor 212 and the earpiece audio sensor 220 may detect any audio signal going from either the handset 102 to the base 101 or vice versa. Thus, once a phone call is placed through the phone 100, regardless of whether the user on phone 100 utters the first word, that call may be detected by at least one of the two sensors 212, 216.

In an exemplary embodiment, the off-hook detection device 202 may include a Voice Operated eXchange (VOX) switch (not shown) in order to detect the voice energy level during a phone conversation. In an exemplary embodiment, the VOX switch may initiate recording of a phone conversation if voice energy level is detected above a certain threshold and may stop the recording if the voice energy falls below a certain lower threshold. In an exemplary embodiment, the off-hook detection device 202 may also include an audio processor 220 coupled to the microphone audio sensor 212 and/or the earpiece audio sensor 216. In an exemplary embodiment, the audio processor 220 may monitor any signal detected by the VOX (not shown). In an exemplary embodiment, the VOX may include the earpiece audio sensor 216 and/or the microphone audio sensor 212. In an exemplary embodiment, the audio processor 220 may determine that a conversation has started on the phone 100 if the energy (i.e. power) level of the audio detected by the VOX on the earpiece channel 130 is above a certain trigger energy threshold. In an alternative exemplary embodiment, the audio processor 220 may make this determination based on the audio energy level on the microphone channel 132 or the combined energy level of both channels 130, 132.

An advantage of this exemplary arrangement is that, since the device attaches to the headset, there is no need to configure the device 202 to the telephone's internal design. However, relying solely on the VOX switch to detect the on-hook/off-hook status of the phone may be problematic under some circumstances, such as, e.g., but not limited to, where both parties are silence for a long period or where one party is placed on hold and there is no music playing. In such circumstances, the voice energy may fall below the lower threshold the thus the device 202 may stop the recording. Further, once the parties carry on their conversation, the VOX switch may incorrectly initiate an entirely new recording, thus breaking a single conversation into multiple recordings.

One way to deal with this issue is by measuring changes in the electrical impedance of the handset using variations of voltage and current to determine the phone's off-hook status. For example, U.S. Pat. No. 6,687,344 discloses detecting the status of a telephone handset by measuring the power of a constant reference signal and measuring the power of an instantaneous signal on the connection and comparing these two measurements. Using this approach, the off-hook detection device can determine whether there has been a change in status of the telephone handset by comparing the detected status with a previous status of the telephone handset.

Although this approach works well in some phones, it may be problematic with many VoIP phones. In most VoIP phones the ADC 110 and DAC 112 are powered even when the phone is on-hook. Thus, when the phone is on-hook, a small amount of ambient noise in the room may trigger the microphone to send audio through the DAC, which may then trigger the recording in the off-hook detection device. For example, the phone operator may hang up the phone and begin typing on a keyboard adjacent to the telephone, which will cause the recording to continue even though the conversation has ended.

According to an exemplary embodiment, the audio energy level may be calculated using the VOX to measure the voltage and/or current on the earpiece channel 130 and/or the microphone channel 132. In an exemplary embodiment, the trigger energy threshold may have a predetermined value which may vary with the phone type and may be typically high enough to indicate that the audio corresponds to a conversation conducted on the phone and not background noise picked up by the microphone 108 or the earpiece 106. In one exemplary embodiment, the audio processor 220 may be configured to operate in a learn mode, wherein the audio processor 220 may adjust the value of the trigger energy threshold to adapt to the specific phone 100 with which the device 202 is being used. In an exemplary embodiment, the threshold may be adjusted via a configurable parameter.

In a further exemplary embodiment, in order to minimize the possibility of a false trigger and to ensure that the audio picked up from the earpiece channel 130 (and/or in some embodiments, the microphone channel 132) is in fact human conversation and not background noise, the detected audio may be broken into a predetermined number of fragments (e.g., but not limited to, five (5) fragments) of predetermined time span (e.g., but not limited to, 1 to 1.2 seconds). The audio energy level of each fragment may then be measured to determine that each fragment energy level exceeds the trigger energy threshold. In an exemplary embodiment, if the energy levels of all fragments are determined to be above the trigger energy threshold, it may be presumed that a conversation is being conducted over the phone. In an exemplary embodiment, other criteria may be used to infer that a conversation has begun.

In an exemplary embodiment, once the audio processor 220 determines that the audio energy level exceeds the trigger energy threshold, the audio processor 220 may begin recording the conversation being conducted through both channels 130, 132. In a further exemplary embodiment, the off-hook detection device 202 may also include an announcement unit 218a, which may play an audio recording, alerting one or both users that the conversation is being recorded for quality assurance purposes. The announcement may be played prior to or after the initiation of the recording. In an alternative exemplary embodiment, the off-hook detection device 202 may include a beep generator 218b, which may generate a beep-tone once every, e.g., but not limited to, 12 to 17 second. The announcement unit 218a and the beep generator unit 218b may be hardware, software, firmware, or any combination thereof. The beep tone may be a signal in the range of, e.g., but not limited to, 1100 to 1700 Hz. Both the announcement and the beep-tone may satisfy the requirement of FCC's privacy rules on recording conversations, which require the use of a recording device to be preceded by a verbal notification recorded at the beginning of the call by the recording party, or that the device be accompanied by a beep tone that automatically produces a distinct signal that is repeated at regular intervals during the course of the telephone conversation when the recording device is in use.

According to an exemplary embodiment of the invention, during the recording of the conversation, the audio processor 220 may monitor the signals detected by the earpiece audio sensor 216 and/or the microphone audio sensor 212 in order to determine when the conversation ends so that the recording can be stopped. In an exemplary embodiment, to determine the end of the conversation, the audio processor 220 may measure the energy level of the audio through the earpiece channel 130 and the microphone channel 132 and may determine whether that energy level has fallen below a certain wrap-up threshold. If the audio energy level falls below the wrap-up threshold, according to an exemplary embodiment, the audio processor 220 may presume the end of the conversation. In an exemplary embodiment, if the end of the conversation is presumed, the audio processor 220 may take further steps as described below to ensure the phone is no longer off-hook before terminating the recording. In one exemplary embodiment, the end of the call may be presumed if the combined energy of the earpiece channel 130 and the microphone channel is below the wrap-up energy threshold.

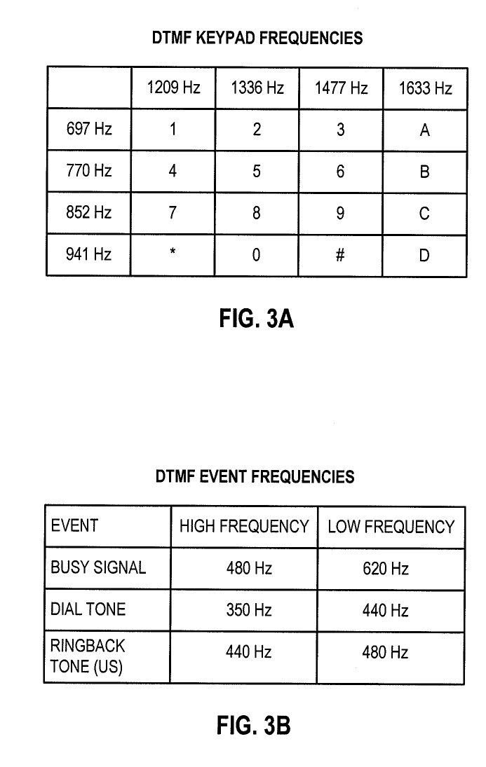

In an exemplary embodiment, the off-hook detection device 202 may include a Voice Operated eXchange (VOX) switch (not shown in FIG. 3) which may trigger the start of the recording when the audio energy level passes above the trigger energy threshold. Similarly, the VOX switch may indicate the end of the recording when the audio energy level falls below the wrap-up energy threshold. In an exemplary embodiment, the VOX switch may be coupled to the audio processor 220, where the VOX switch may detect the beginning and end of a conversation based on the voice energy level and the audio processor 220 may initiate and terminate the recording based on the VOX output.

In an exemplary embodiment, the trigger energy threshold and the wrap-up energy threshold may depend on the phone type. In an exemplary embodiment, where the ADC 204 and/or ADC 210 may include a 16 bit codec which may have a swing of 0 to 65536 with a midpoint of 32768. In an exemplary embodiment, the trigger energy threshold may be set to 3600 to 6700 above the midpoint and the wrap-up energy threshold may be set to 3400 to 6500 above the midpoint. In an exemplary embodiment, the trigger energy threshold and the wrap-up energy threshold may correspond to the gain levels from the handset 102. Thus, in an exemplary embodiment, the trigger energy threshold may occur at 0.98 db gain from the earpiece channel 130 and the wrap-up energy threshold may occur at 0.90 db gain from the earpiece channel 130 and the microphone channel 132 combined.

In some embodiments, it is possible for the audio energy level to fall below the wrap-up energy threshold during the phone call such as, e.g., but not limited to, where short pauses occur in the conversation. Thus, in an exemplary embodiment, instead of immediately presuming that the call has ended, the audio processor 220 may continue to monitor the audio for up to wrap-up duration period. In this embodiment, if the audio energy level is below the wrap-up energy threshold for the duration of the wrap-up duration period, then the audio processor 220 may presume that the call has ended. In an exemplary embodiment, the wrap-up duration period may be, e.g., but not limited to, 3 seconds.

In an exemplary embodiment of the invention, even if the wrap-up duration period is set to a reasonably high value, e.g., 3-5 seconds, the audio level may still fall below the wrap-up energy threshold in situations such as, e.g., but not limited to, long pauses during the conversation or when one of the users is placed on hold and there is no music playing during the hold. In order to prevent the recording from stopping under these circumstances, in an exemplary embodiment of the invention, the off-hook detection device 202 may take further steps to examine whether the phone is in fact on-hook. According to an exemplary embodiment, the off-hook detection device 202 injects an identifiable signal into the microphone channel 132 of the phone 100 and monitors the earpiece channel 130 to detect the injected signal in the sidetone. In an exemplary embodiment, if the injected signal is detected in the sidetone, there may be an indication that the phone is still off-hook and it may be inferred that the low audio energy level may be due to, e.g., but not limited to, a long pause or hold. However, if the injected signal is not detected in the sidetone, the off-hook detection device 202 may determine that the phone is on-hook and stop the recording.

According to an exemplary embodiment, the injected signal may be non-intrusive. A non-intrusive signal may be transparent to the telephony equipment without affecting the timing, the processing characteristics, or the behavior of the telephony hardware and/or software. The non-intrusive signal may be indiscernible to the telephone calling parties. In an exemplary embodiment, the injected signal may be a sub-band signal.

A variety of phones types made by various manufacturers have been tested pursuant to this invention to ensure that an off-hook detection device according to the aforementioned exemplary embodiment of the invention would work as desired with a wide range of existing phones. A list of phones tested for this purpose includes, but is not limited to, the POTS AT & T 742, the AT & T (957/8102), the Cisco 7912, the 3Com 2120 PE, the NEC DTU 8D 2, the Comdial 8012S Impact, and Polycom. According to the test results, in all these phones, an identifiable signal injected into the microphone channel of the headset was detected when the phone was off-hook, whereas no sidetone was detected when the phone was on-hook. Thus, an off-hook according to this embodiment may detect the phone's off-hook status by injecting the identifiable signal and determining whether the signal is detected in a sidetone on the phone's earpiece channel.

In an exemplary embodiment, the off-hook detection unit 202 may include a signal generator 214 coupled to the audio processor 220 and the DAC 206 which, upon invocation by the audio processor 220, may inject a signal through the DAC 206 into the phone's microphone channel 132. In an exemplary embodiment, the audio processor 220 may invoke the signal generator 214 to inject the signal immediately or at some time after the audio energy level of the microphone channel 132 and/or the earpiece channel 130 falls below the wrap-up energy threshold. In an exemplary embodiment, after the signal is injected in the microphone channel 132, the audio processor 220 may monitor the signals detected by the earpiece audio sensor 216 to determine whether a sidetone has been detected for the injected signal.

In an exemplary embodiment, the audio processor 220 may perform a Fourier Transform, e.g., Fast Fourier Transform (FFT) or Direct Fourier Transform (DFT), on the signals detected on the earpiece channel 220 to determine if any correspond to the injected signal. In one exemplary embodiment, the audio processor 220 may perform the Goertzel algorithm on the detected signals. The Goertzel algorithm a computational efficient method of detecting a signal, usually used to detect DTMF tones. The Goertzel algorithm may be much less CPU intensive than the FFT and can provide the probability that a signal detected in the sidetone has the same frequency as the injected signal, i.e., the detected signal is the sidetone of the injected signal.

While running the Goertzel algorithm takes up less CPU time than running the Fourier Transform, the Goertzel algorithm may still consume too much processing time in some embodiments. Thus, in another exemplary embodiment of the invention, the audio processor 220 may monitor the zero-crossings on the signals detected on the earpiece channel 130 in order to estimate whether the injected signal is detected in the sidetone of the earpiece channel 130. In other words, in an exemplary embodiment, if the zero-crossings indicate the existence of a signal that has the same frequency as the injected signal, it is likely that the detected signal in the sidetone corresponds to the injected signal.

In a further exemplary embodiment of the invention, the audio processor 220 may use zero-crossings to nominate a signal or a group of signals that are likely to be the injected signal. Then, the audio processor 220 may use the Goertzel algorithm on nominated signals to determine with higher certainty if any of them correspond to the injected signal. According to this exemplary embodiment, the Goertzel algorithm is ran on a lower number of signals, thus avoiding unnecessary usage of microprocessor time.

In some embodiments of the invention, if no sidetone is detected for a single injected signal, it is possible that the injected signal is undetected in the sidetone by error. To alleviate this problem, in an exemplary embodiment, instead of injecting a single signal into the microphone channel 132, the signal generator 214 may inject a series of signals into the microphone channel 132 for a period of maximum sidetone wrap-up duration and may look for the sidetones for these signals at the earpiece channel 130. In an exemplary embodiment, the maximum sidetone wrap-up duration may be adjusted depending on the phone and may be, e.g., but not limited to, between 2 to 5 seconds. Further, in an exemplary embodiment, the signals may be injected within the maximum sidetone wrap-up duration period once every, e.g., but not limited to, 2 seconds. In such an embodiment, if the maximum sidetone wrap-up duration is set to, e.g., 2 or 3 seconds, two signals may be injected and if the maximum sidetone wrap-up duration is set to, e.g., 4 or 5 seconds, three signals may be injected into the microphone channel 132. In an exemplary embodiment, if none of the injected signals are detected in the sidetone within the maximum sidetone wrap-up duration period, the recording of the conversation may be terminated.

In some embodiments, when the audio energy is below the wrap-up energy threshold, it is possible that the off-hook detection device continuously injects signals into the microphone channel 132 and the sidetones for the injected signals are detected at the earpiece channel 130, yet the audio energy remains below the wrap-up energy threshold. Such circumstances could occur if, e.g., but not limited to, the phone handset 102 is not placed properly on the telephone 101 or if the phone switch erroneously places sidetones in the phone's earpiece channel 130. Under these circumstances, in an exemplary embodiment, the audio processor 220 stops the recording if, for a maximum sidetone fallback duration period, the audio energy remains below the wrap-up energy threshold and a sidetone is detected in the earpiece channel 130 for the signals injected into the microphone channel 132. In an exemplary embodiment, the maximum sidetone fallback duration period may be, e.g., but not limited to, 1 hour.

Further, according to an exemplary embodiment of the invention, if the phone audio does not fall below the wrap-up energy threshold for a period of maximum record duration period, which may be, e.g., but not limited to, 2 hours, then the audio processor 220 may also stop the recording.

In an exemplary embodiment, the signal that is injected into the microphone channel 132 may have a specific sub-band frequency. The human hearing range is from 20 Hz to about 20 kHz, while the phone band is typically in the range of about 300 Hz to about 3 kHz. Thus, if the generated signal has a frequency of less than about 300 Hz, it is barely audible on the phone. In an exemplary embodiment, the generated signal may have a frequency of e.g., but not limited to, about 100 Hz.

In an exemplary embodiment, it may also be important to distinguish the generated signal from the existing DTMF (Dual-Tone Multi-Frequency) signals. As depicted in FIG. 3A, all keypad DTMF tones currently used worldwide are within the range of 697-941 Hz for the low frequency tone and in the range of 1209-1633 Hz for the high frequency tone. Further, as depicted in FIG. 3B, all DTMF event tones (e.g., busy signal, dial tone, and ringback tone) are within the range of 350-620 Hz. Thus, in an exemplary embodiment, a signal with a frequency of less than about 300 Hz may be distinguishable from the existing DTMF signal. However, if the generated signal has a frequency that is too close to a factor of a DTMF signal (i.e., one of the DTMF signals is close to divisible by the signal frequency), then the harmonics of the DTMF signal may overlap with the harmonics of the generated signal at certain zero-crossings. It has been concluded by experimentation that a frequency of about 100 Hz results in the lowest chance of confusing the zero-crossings of the generated signal with the zero-crossings of a DTMF tone. Further, it has been found that the Goertzel algorithm produces the highest confidence level in detecting a 100 Hz signal than any other sub-band signal. Thus, in an exemplary embodiment, the generated signal has a frequency of 100 Hz.

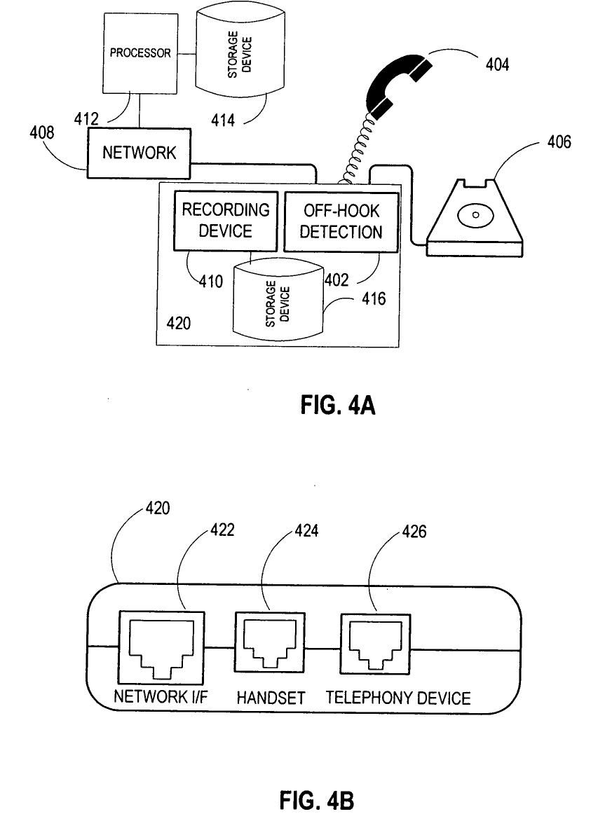

FIG. 4A depicts an exemplary off-hook detection device 402 coupled between the telephone base 406 and the telephone handset 404 according to an exemplary embodiment of the present invention. In an exemplary embodiment, the off-hook detection device 402 may be coupled to a network 408 such as the Internet, where the recorded data can be transferred to and stored on, e.g., a recording database using a processor 412 and a storage device 414. The off-hook detection device 404 may be coupled to a recording device 410 or other storage medium. In an exemplary embodiment, the off-hook detection device 402 may be part of an interface device 420, which may include a recording device 410, a network interface (not shown) 422, and a storage device 416.

FIG. 4B depicts a side-view of an off-hook detection device interface 420 according to an exemplary embodiment of the present invention. The exemplary interface 420 depicted in FIG. 4B may include a network interface port 422, a handset port 424 (in which the telephone handset may be plugged), and a telephony device port 426 (from which a handset cable may be plugged into a handset port of the telephony device 406).

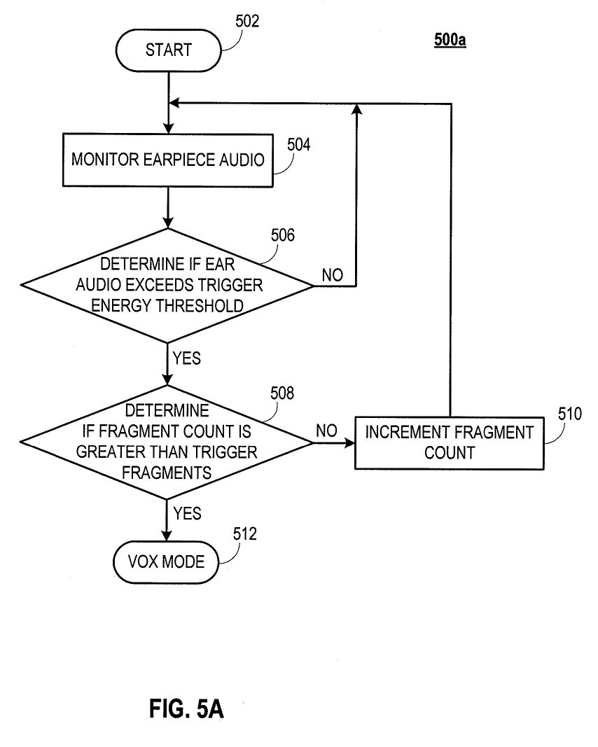

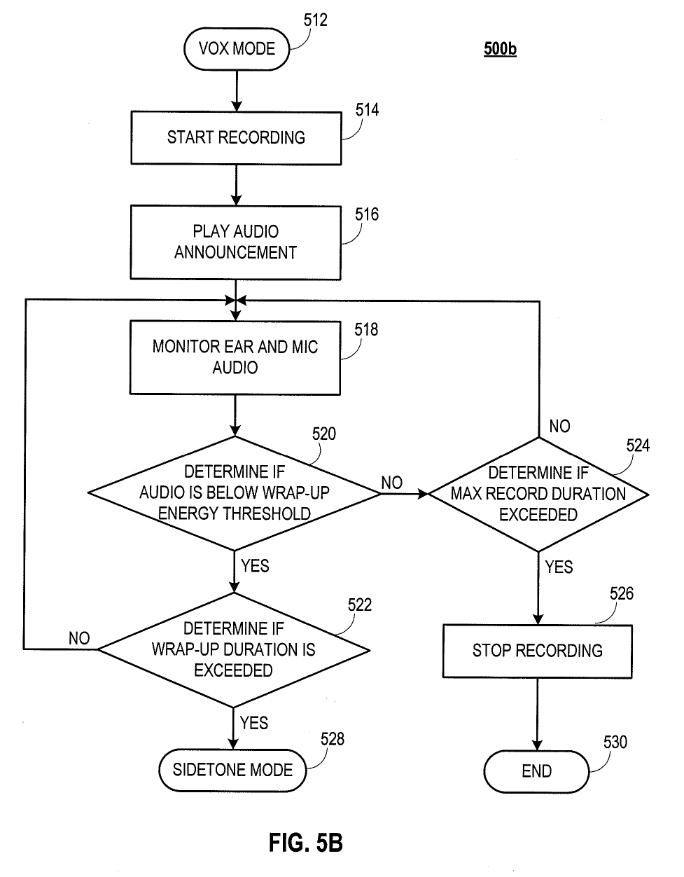

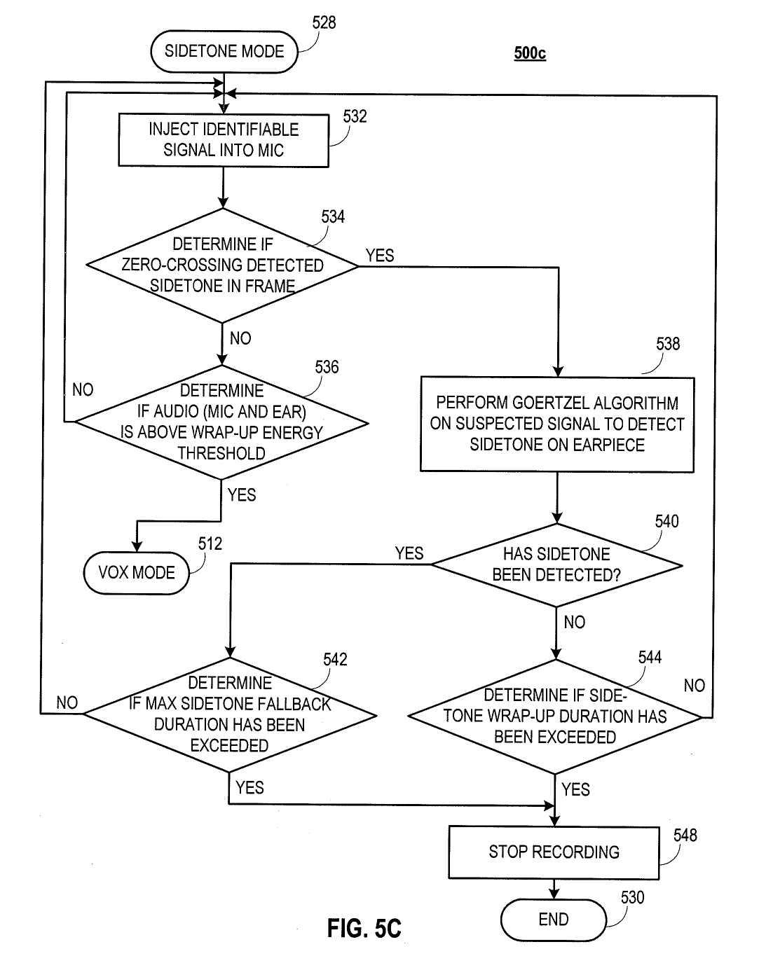

Referring now to FIGS. 5A-C, collectively, there is depicted an exemplary process 500 of off-hood detection has been depicted according to an exemplary embodiment of the present invention. In FIG. 5A, the exemplary process 500a may start, in an exemplary embodiment, with 502. From 502, in an exemplary embodiment, the process 500a may proceed to 504, where the earpiece channel of telephone may be monitored for any incoming audio. In alternative embodiments, both the earpiece channel and the microphone channel may be monitored for any audio going into or out of the telephone. From 504, the process may continue to 506, where a determination may be made as to whether the audio (e.g. earpiece audio and/or microphone audio) energy level exceeds the trigger energy threshold. In an exemplary embodiment, if the trigger energy level has not been exceeded, the process 500a may continue monitoring the earpiece channel (and/or the microphone channel) in 504. If, however, the trigger energy level has been exceeded, in an exemplary embodiment, the process 500a may continue to 508.

In an exemplary embodiment, in 508, a determination may be made as to whether the fragment count is greater than the predetermined number of trigger fragments. If not, the process 500a may continue to 510, where the fragment count may be incremented and the process 500a may be led back to 504. Through these steps, the process 500a may monitor the earpiece audio for a predetermined number of fragments of audio and, if the ear audio exceeds the trigger energy threshold for each fragment, the process 500a may continue to 512, which, in an exemplary embodiment, is referred to as the VOX mode.

In FIG. 5B, the exemplary process 500b may start, in an exemplary embodiment, with VOX mode at 512. From 512, in an exemplary embodiment, the process 500b may proceed to 514, where the recording of the phone conversation is initiated. From 514, in an exemplary embodiment, the process 500b may continue to 516, where an audio announcement may be played through the phone, e.g., alerting the user that that conversation is being recorded for quality assurance purposes. In an alternative exemplary embodiment, the process 500b may play a beep-tone at, e.g., but not limited to, every 12-17 seconds. From 516, in an exemplary embodiment, the process 500b may proceed to 518, where the audio channels of both the microphone and the earpiece may be monitored for incoming and outgoing signals through the phone headset. From 518, in an exemplary embodiment, the process 500b may continue to 520, where a determination is made as to whether the audio energy level is below a wrap-up energy threshold. The wrap-up energy threshold may indicate the energy level below which it may be inferred that the audio through the phone does not represent a telephone conversation. If the audio energy level is below the wrap-up energy threshold, then the process 500b may continue to 522, where a determination may be made as to whether the wrap-up duration is exceeded. In an exemplary embodiment, the wrap-up duration may be, e.g., but not limited to, 3 seconds, and may represent the time for which the energy level should be below the wrap-up energy threshold before the conversation is presumed to have terminated. In an exemplary embodiment, if the wrap-up duration has not been exceeded, the process 500b may be led back to 518, where it may continue to monitor the earpiece and microphone audio. If the wrap-up duration has been exceeded, the process 500b may continue to 528, which, in an exemplary embodiment, is referred to as the sidetone mode.

In an exemplary embodiment, if the audio is not below the wrap-up energy threshold in 520, the process 500b may continue to 524, where a determination may be made as to whether the maximum record duration has been exceeded. The maximum record duration, which may be, e.g, but not limited to, 2 hours, may indicate the maximum time that a recording of a single conversation may last. From 524, if the maximum record duration has been exceeded, the process 500b may stop the recording in 526 and end at 530. Otherwise, the process 500b may be led back to 518, where it continues to monitor the microphone and earpiece audio.

In FIG. 5C, in an exemplary embodiment, the exemplary process 500c may start with sidetone mode at 528 and may continue to 532, where an identifiable signal is injected into the microphone channel. From 532, in an exemplary embodiment, the process 500c may continue with 534, where a determination may be made as to whether zero-crossings of a sidetone for the injected sidetone have been detected within a frame of the earpiece channel. If so, the process 500c may continue to 538, where it may perform the Goertzel algorithm on the suspected sidetone signal to determine whether that sidetone signal in fact corresponds to the injected signal.

In an exemplary embodiment, the process 500c may continue from 538 to 540, where a determination may be made as to whether the results of the Goertzel algorithm indicate that the suspected signal detected in the sidetone corresponds to the injected signal. If not, the process may continue to 544, where a determination may be made as to whether the sidetone wrap-up duration has been exceeded. In an exemplary embodiment, the sidetone wrap-up duration may be, e.g., but not limited to, 2-5 seconds and may indicate the time during which a series of signals are to be injected into the microphone channel and their sidetones are looked for on the earpiece channel before the recording can be stopped. If the sidetone wrap-up duration has not been exceeded, the process 500c may continue back to 532. Otherwise, the process 500c may continue to 548, which it may stop the recording, and then may end at 530.

In an exemplary embodiment, if at 540 a sidetone is detected for an injected signal, the process 500c may continue to 542, where a determination may be made as to whether the maximum sidetone fallback duration period has been exceeded. The maximum sidetone fallback duration period may be, e.g., but not limited to, 1 hour and may indicate the maximum amount of time that the process may remain in the sidetone mode without terminating the recording. If the maximum sidetone fallback duration period has been exceeded, the process 500c may continue to 548, which it may stop the recording, and then may end at 530.

In an exemplary embodiment, if it is determined at 534 that no zero-crossings of a sidetone for the injected sidetone have been detected within a frame of the earpiece channel, the process 500c may continue to 536, where a determination may be made as to whether the total audio energy on the microphone and earpiece channels is above the wrap-up energy threshold. If so, the process 500c may be led back to VOX mode in 512. Otherwise, the process 500c may be led back to 532, where it may inject a new signal into the microphone channel.

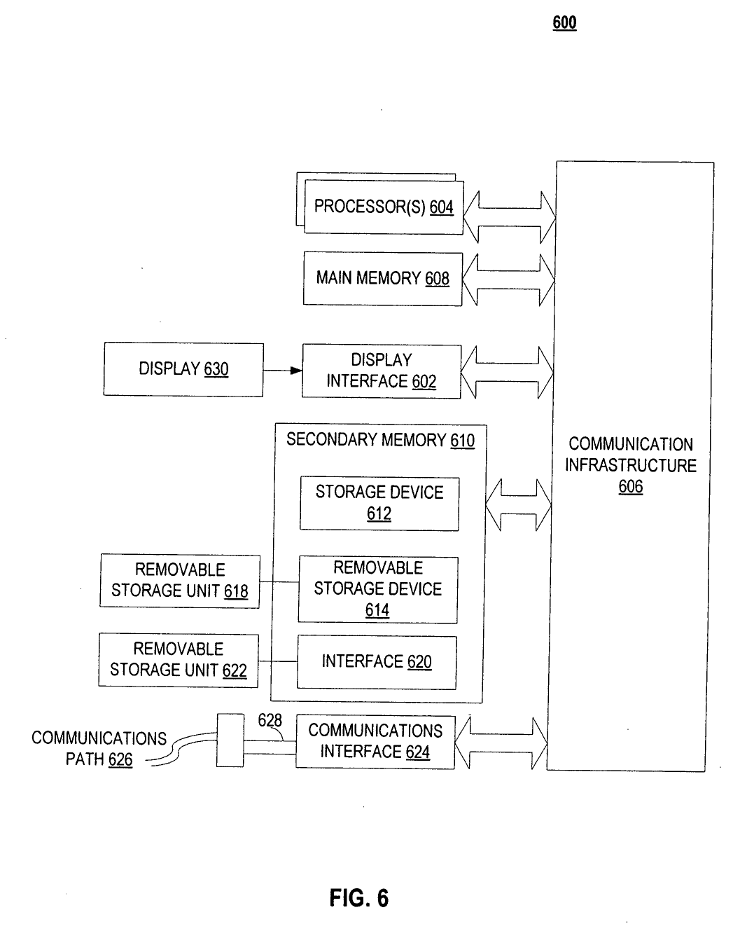

FIG. 6 depicts an exemplary computer system that may be used in implementing an exemplary embodiment of the present invention. Specifically, FIG. 6 depicts an exemplary embodiment of a computer system 600 that may be used in computing devices such as, e.g., but not limited to, a client and/or a server, etc., according to an exemplary embodiment of the present invention. FIG. 6 depicts an exemplary embodiment of a computer system that may be used as client device 600, or a server device 600, etc. The present invention (or any part(s) or function(s) thereof) may be implemented using hardware, software, firmware, or a combination thereof and may be implemented in one or more computer systems or other processing systems. In fact, in one exemplary embodiment, the invention may be directed toward one or more computer systems capable of carrying out the functionality described herein. An example of a computer system 600 may be shown in FIG. 6, depicting an exemplary embodiment of a block diagram of an exemplary computer system useful for implementing the present invention. Specifically, FIG. 6 illustrates an example computer 600, which in an exemplary embodiment may be, e.g., (but not limited to) a personal computer (PC) system running an operating system such as, e.g., (but not limited to) MICROSOFT® WINDOWS® NT/98/2000/XP/CE/ME/etc. available from MICROSOFT® Corporation of Redmond, Wash., U.S.A. However, the invention may not be limited to these platforms. Instead, the invention may be implemented on any appropriate computer system running any appropriate operating system. In one exemplary embodiment, the present invention may be implemented on a computer system operating as discussed herein. An exemplary computer system, computer 600 may be shown in FIG. 6. Other components of the invention, such as, e.g., (but not limited to) a computing device, a communications device, mobile phone, a telephony device, a telephone, a personal digital assistant (PDA), a personal computer (PC), a handheld PC, an interactive television (iTV), a digital video recorder (DVD), client workstations, thin clients, thick clients, proxy servers, network communication servers, remote access devices, client computers, server computers, routers, web servers, data, media, audio, video, telephony or streaming technology servers, etc., may also be implemented using a computer such as that shown in FIG. 6. Services may be provided on demand using, e.g., but not limited to, an interactive television (iTV), a video on demand system (VOD), and via a digital video recorder (DVR), or other on demand viewing system.

The computer system 600 may include one or more processors, such as, e.g., but not limited to, processor(s) 604. The processor(s) 604 may be connected to a communication infrastructure 606 (e.g., but not limited to, a communications bus, cross-over bar, or network, etc.). Various exemplary software embodiments may be described in terms of this exemplary computer system. After reading this description, it may become apparent to a person skilled in the relevant art(s) how to implement the invention using other computer systems and/or architectures.

Computer system 600 may include a display interface 602 that may forward, e.g., but not limited to, graphics, text, and other data, etc., from the communication infrastructure 606 (or from a frame buffer, etc., not shown) for display on the display unit 630.

The computer system 600 may also include, e.g., but may not be limited to, a main memory 608, random access memory (RAM), and a secondary memory 610, etc. The secondary memory 610 may include, for example, (but not limited to) a hard disk drive 612 and/or a removable storage drive 614, representing a floppy diskette drive, a magnetic tape drive, an optical disk drive, a compact disk drive CD-ROM, etc. The removable storage drive 614 may, e.g., but not limited to, read from and/or write to a removable storage unit 618 in a well known manner. Removable storage unit 618, also called a program storage device or a computer program product, may represent, e.g., but not limited to, a floppy disk, magnetic tape, optical disk, compact disk, etc. which may be read from and written to by removable storage drive 614. As may be appreciated, the removable storage unit 618 may include a computer usable storage medium having stored therein computer software and/or data. In some embodiments, a “machine-accessible medium” may refer to any storage device used for storing data accessible by a computer. Examples of a machine-accessible medium may include, e.g., but not limited to: a magnetic hard disk; a floppy disk; an optical disk, like a compact disk read-only memory (CD-ROM) or a digital versatile disk (DVD); a magnetic tape; and a memory chip, etc.

In alternative exemplary embodiments, secondary memory 610 may include other similar devices for allowing computer programs or other instructions to be loaded into computer system 600. Such devices may include, for example, a removable storage unit 622 and an interface 620. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 622 and interfaces 620, which may allow software and data to be transferred from the removable storage unit 622 to computer system 600.

Computer 600 may also include an input device 616 such as, e.g., (but not limited to) a mouse or other pointing device such as a digitizer, and a keyboard or other data entry device (not shown).

Computer 600 may also include output devices, such as, e.g., (but not limited to) display 630, and display interface 602. Computer 600 may include input/output (I/O) devices such as, e.g., (but not limited to) communications interface 624, cable 628 and communications path 626, etc. These devices may include, e.g., but not limited to, a network interface card, and modems (neither are labeled). Communications interface 624 may allow software and data to be transferred between computer system 600 and external devices.

In this document, the terms “computer program medium” and “computer readable medium” may be used to generally refer to media such as, e.g., but not limited to removable storage drive 614, a hard disk installed in hard disk drive 612, and signals 628, etc. These computer program products may provide software to computer system 600. The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms may be not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm may be here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it may be appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device. In yet another exemplary embodiment, the invention may be implemented using a combination of any of, e.g., but not limited to, hardware, firmware and software, etc.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A system for off-hook detection of a telephony device comprising:
an earpiece audio sensor operative to detect an earpiece audio signal associated with a telephone call on an earpiece channel of a handset of the telephony device;
a signal generator arranged to inject a signal having a predetermined frequency into a microphone channel of the handset the telephony device; and
an audio processor configured to initiate a recording of the telephone call upon said earpiece audio sensor detecting said earpiece audio signal and to terminate said recording if said injected signal is not detected in a sidetone on said earpiece channel.

2. The system of claim 1, wherein said audio processor is configured to initiate said recording if said earpiece audio signal has an energy level greater than a trigger energy threshold.

3. The system of claim 1, wherein said audio processor is configured to initiate said recording if, for a predetermined number of fragments of said earpiece audio, an energy level of each fragment exceeds a trigger energy threshold.

4. The system of claim 1, wherein said audio processor is operative to play an audio announcement at a beginning of the telephone call alerting a user that the telephone call is being recorded for quality assurance purposes.

5. The system of claim 1, wherein said audio processor is operative to play a beep tone to a user at predetermined time intervals indicating that the telephone call is being recorded.

6. The system of claim 1, further comprising a microphone audio sensor arranged to detect a microphone audio signal of the handset associated with the telephone call on said microphone channel of the handset of the telephony device,
wherein said microphone audio sensor and said earpiece audio sensor detect an audio signal associated with the telephone call prior to said signal generator injecting said injected signal into the microphone channel,
wherein said signal generator is configured to inject said injected signal into said earpiece channel if an end of the telephone call is presumed,
wherein said end of the telephone call is presumed if a minimal amount of audio energy is detected on the earpiece audio channel and/or the microphone audio channel.

7. The system of claim 6, wherein said end of the telephone call is presumed if a combined audio energy level on the earpiece audio channel and the microphone audio channel is below a wrap-up energy threshold.

8. The system of claim 7, further comprising a VOX switch to determine whether said combined audio energy level is below said wrap-up energy threshold.

9. The system of claim 6, wherein said end of the telephone call is presumed if a combined audio energy level on the earpiece audio channel and the microphone audio channel is below a wrap-up energy threshold for a minimum of a wrap-up duration period.

10. The system of claim 1, wherein said audio processor is further operative to terminate said recording if a combined audio energy level on the earpiece audio channel and the microphone audio channel is above a wrap-up energy threshold for a maximum record duration period.

11. The system of claim 1, wherein said injected signal comprises a non-intrusive sub-band signal.

12. The system of claim 11, wherein said injected signal has an audio frequency of approximately 100 Hz.

13. The system of claim 1, wherein said earpiece audio sensor is operative to monitor said earpiece channel to detect said injected signal in the sidetone.

14. The system of claim 13, wherein said audio processor is further operative to measure zero-crossings on said earpiece channel to detect a candidate sidetone signal likely to correspond to said injected signal.

15. The system of claim 13, wherein said audio processor is further operative to detect said injected signal in the sidetone using a Goertzel algorithm.

16. The system of claim 13, wherein said signal generator is arranged to inject a plurality of signals into said microphone channel and said audio processor is operative to terminate said recording if said plurality of injected signals are not detected on the earpiece channel for a sidetone wrap-up duration period.

17. The system of claim 13, wherein said signal generator is arranged to inject a plurality of signals into said microphone channel and said audio processor is operative to terminate said recording if, for each of said plurality of injected signals, said injected signal is detected on the earpiece channel for a maximum sidetone fallback duration period.

18. A method for off-hook detection of a telephony device comprising:
monitoring an earpiece channel of a handset of the telephony device to detect an earpiece audio signal associated with a telephone call;
initiating a recording of the telephone call upon detecting said earpiece audio signal on the earpiece channel;
injecting a signal having a predetermined frequency into a microphone channel of the handset of the telephony device; and
terminating said recording if said injected signal is not detected in a sidetone on said earpiece channel.

19. The method of claim 18, wherein said recording is initiated if said earpiece audio signal has an energy level greater than a trigger energy threshold.

20. The method of claim 18, wherein said recording is initiated if, for a predetermined number of fragments of said earpiece audio, an energy level of each fragment exceeds a trigger energy threshold.

21. The method of claim 18, further comprising playing an audio announcement at a beginning of the telephone call alerting a party to the telephone call that the telephone call is being recorded for quality assurance purposes.

22. The method of claim 18, further comprising playing a beep tone to a party to the telephone call at predetermined time intervals, indicating that the telephone call is being recorded.

23. The method of claim 18, further comprising monitoring the earpiece and the microphone channels of the handset to detect audio associated with the telephone call prior to injecting said injected signal into the microphone channel, wherein an end of the telephone call is presumed if minimal audio is detected on either the earpiece audio channel or the microphone audio channel, wherein said injected signal is injected into said earpiece channel if said end of the telephone call is presumed.

24. The method of claim 23, wherein said end of the telephone call is presumed if a combined audio energy level on said earpiece audio channel and said microphone audio channel is below a wrap-up energy threshold.

25. The method of claim 24, wherein a VOX switch is used to determine whether said combined audio energy level on said earpiece audio channel and said microphone audio channel is below said wrap-up energy threshold.

26. The method of claim 23, wherein said end of the telephone call is presumed if a combined audio energy level on said earpiece audio channel and said microphone audio channel is below a wrap-up energy threshold for a minimum of a wrap-up duration period.

27. The method of claim 18, further comprising terminating said recording if a combined audio energy level on said earpiece audio channel and said microphone audio channel is above a wrap-up energy threshold for a maximum record duration period.

28. The method of claim 18, wherein said injected signal comprises a non-intrusive sub-band signal.

29. The method of claim 28, wherein said injected signal has an audio frequency of approximately 100 Hz.

30. The method of claim 18, wherein said terminating comprises monitoring said earpiece channel of the handset to detect said injected signal in the sidetone.

31. The method of claim 30, wherein said terminating further comprises measuring zero-crossings on said earpiece channel to detect a candidate sidetone likely to correspond to said injected signal.

32. The method of claim 30, wherein said terminating further comprises detecting said injected signal in the sidetone using a Goertzel algorithm.

33. The method of claim 30, wherein said terminating further comprising detecting said injected signal in the sidetone using at least one of a FFT algorithm and/or a DFT algorithm.

34. The method of claim 30, further comprising:
injecting a plurality of signals into said microphone channel for a sidetone wrap-up duration period;
monitoring said earpiece channel for at least one sidetone corresponding to at least one of said plurality of injected signals; and
terminated said recording if none of said plurality of injected signals is detected on the earpiece channel.

35. A computer readable medium embodying program logic, which, when executed, performs a method comprising:
monitoring an earpiece channel of a handset of the telephony device to detect an earpiece audio signal associated with a telephone call;
initiating a recording of the telephone call upon detecting said earpiece audio signal on the earpiece channel;
injecting a signal having a predetermined frequency into a microphone channel of the handset of the telephony device; and
terminating said recording if said injected signal is not detected in a sidetone on said earpiece channel.

36. The method of claim 35, wherein said recording is initiated if said earpiece audio signal has an energy level greater than a trigger energy threshold.

37. The method of claim 35, further comprising monitoring the earpiece and the microphone channels of the handset to detect audio associated with the telephone call prior to injecting said injected signal into the microphone channel, wherein an end of the telephone call is presumed if minimal audio is detected on either the earpiece audio channel or the microphone audio channel, wherein said injected signal is injected into said earpiece channel if said end of the telephone call is presumed.

38. The method of claim 37, wherein said end of the telephone call is presumed if a combined audio energy level on said earpiece audio channel and said microphone audio channel is below a wrap-up energy threshold for a minimum of a wrap-up duration period.

39. The method of claim 35, wherein said injected signal comprises a non-intrusive sub-band signal.

40. The method of claim 35, wherein said terminating comprises monitoring said earpiece channel of the handset to detect said injected signal in the sidetone.

41. The method of claim 40, wherein said terminating further comprises measuring zero-crossings on said earpiece channel to detect a candidate sidetone likely to correspond to said injected signal.

42. The method of claim 40, wherein said terminating further comprises detecting said injected signal in the sidetone using at least one of a Goertzel algorithm, a DFT algorithm, and/or a FFT algorithm.
